(19) United States
(12) Patent Application Publication
(10) Pub. No.: US 2005/0135517 A1
(43) Pub. Date: Jun. 23, 2005

(54) Increasing effective number of data tones in a multi-antenna multi-tone communication system

(75) Inventors: John T. Coffey, San Francisco, CA (US); Richard G.C. William, Santa Rosa, CA (US); Srikanth Gummadi, San Diego, CA (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 10/969,118

(22) Filed: Oct. 20, 2004

Related U.S. Application Data
(60) Provisional application No. 60/532,155, filed on Dec. 22, 2003.

(51) Int. Cl. H04L 1/02

(52) U.S. Cl. 375/347

(57) ABSTRACT

A wireless device is provided that includes host logic (53), at least two antennas (59), and network interface logic (57). The network interface logic (57) is operable to transmit packets comprising symbols containing a plurality of data tones on at least two channels (69). The network interface logic (57) varies the number of data tones among the symbols. A first channel (69a) of packets is transmitted over a first antenna (59a) and a second channel (69b) of packets is transmitted over a second antenna (59b).

### CROSS-REFERENCE TO RELATED APPLICATIONS

This application claims priority to U.S. Provisional Application No. 60/532,155 filed Dec. 22, 2003, and entitled “Use of Variable Number of Pilot Tones in Multi-Tone and Multiple Transmit Antenna Wireless Local Area Networks,” incorporated herein by reference.

### STATEMENT REGARDING FEDERALLY SPONSORED RESEARCH OR DEVELOPMENT

Not applicable.

### REFERENCE TO A MICROFICHE APPENDIX

Not applicable.

### FIELD OF THE INVENTION

The present disclosure is directed to communication networks, and more particularly, but not by way of limitation, to increasing the effective number of data tones in a multi-tone, multiple antenna communication system.

### BACKGROUND OF THE INVENTION

In general, communication systems permit data or other signals to be transmitted from a first device to a second device coupled together by a communication channel which may be established wirelessly or over electrical or fiber optical cable. It is generally desirable to maximize data transmission rates within the constraints of the communication system design. Defining a higher rate extension to current wireless local area network (WLAN) systems while retaining as much of the current WLAN structure as possible also is desirable.

### SUMMARY OF THE INVENTION

According to one embodiment, a wireless device is provided that includes host logic, at least two antennas, and network interface logic. The network interface logic is operable to transmit packets comprising symbols containing a plurality of data tones on at least two channels. The network interface logic varies the number of data tones among the symbols. A first channel of packets is transmitted over a first antenna and a second channel of packets is transmitted over a second antenna.

In another embodiment, a wireless device is provided that includes one or more antennas and a receiver component in communication with the one or more antennas. The receiver component is operable to receive two channels of packetized information containing symbols that include a variable number of data tones. The two channels include a first channel of packetized information and a second channel of packetized information.

In yet another embodiment, a method for wireless communication is provided. The method includes determining a number of data tones to include in a first symbol for a first channel and a second symbol for a second channel. The method provides for forming the first symbol with the determined number of data tones, and forming the second symbol with the determined number of data tones. The method includes transmitting the first symbol on the first channel from a first antenna and the second symbol on the second channel from a second antenna. The method also includes changing the number of data tones to form another symbol for the first channel or the second channel.

These and other features and advantages will be more clearly understood from the following detailed description taken in conjunction with the accompanying drawings and claims.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIG. 1 illustrates a communication network according to an embodiment of the disclosure.

FIG. 2 depicts two communication symbols frameworks for implementing an embodiment of the disclosure.

FIG. 3 illustrates an access point and a wireless station in wireless communication over two independent channels according to an embodiment of the disclosure.

FIG. 4a depicts a first symbol pattern according to an embodiment of the disclosure.

FIG. 4b depicts a second symbol pattern according to an embodiment of the disclosure.

FIG. 5 is a block diagram of a device used in the wireless network of FIG. 1.

FIG. 6 is a block diagram of a single channel of a transmitter used in the device of FIG. 5.

FIG. 7 is a block diagram of a single channel of a receiver used in the device of FIG. 5.

FIG. 8 illustrates an exemplary wireless device suitable for implementing the several embodiments of the disclosure.

### DETAILED DESCRIPTION OF THE PREFERRED EMBODIMENTS

It should be understood at the outset that although an exemplary implementation of one embodiment of the present disclosure is illustrated below, the present system may be implemented using any number of techniques, whether currently known or in existence. The present disclosure should in no way be limited to the exemplary implementations, drawings, and techniques illustrated below, including the exemplary design and implementation illustrated and described herein.

Communication systems use multiple frequencies over which to transmit data. The orthogonal frequency division multiplexing (OFDM) modulation technique used in the IEEE 802.11 wireless communication standards may employ, for example, 64 frequency tones spaced at intervals of 312.5 kHz. The frequency tones may be referred to as bins or frequency bins. The 64 tones in the 802.11 standards include 48 data tones, 4 pilot tones, and 12 unused tones. A data tone is a tone on which data may be transmitted. A pilot tone is a tone that may contain information used to promote the coherent demodulation of the transmitted signal at the receiver and are not used to convey message data. The 12 unused tones are included to prevent adjacent interference and are not used to convey message data. The IEEE 802.11 wireless local area network (WLAN) channel structures are used as an example to illustrate various embodiments of the disclosure, however, the disclosure and claims that follow should not to be limited to any particular communication standard.

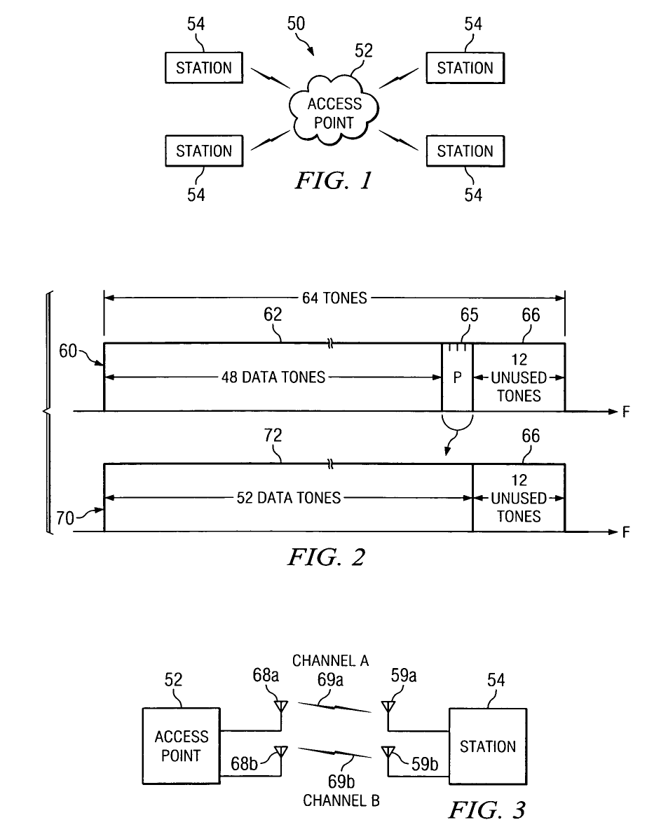

Turning now to FIG. 1, a communication network 50 is illustrated that is implemented in accordance with a preferred embodiment of the disclosure. As shown, the network 50 comprises at least one access point (AP) 52 configured to be wirelessly coupled to communicate with at least one wireless station 54. Four wireless stations 54 are depicted in the exemplary network 50, but in other embodiments either more or fewer wireless stations 54 may be wirelessly coupled to communicate with the access point 52. The access point 52 includes a wired connection (not shown) to a server or other suitable network device (also not shown) whereby the wireless network 50 is connected to a wired network such as the public data network, for example the Internet (not shown). Additional access points 52 may be included as desired thereby permitting wireless stations 54 to wirelessly access the wired network via any of a plurality of access points 52.

In addition to communicating with the access point 52, which may be termed infrastructure mode, the wireless stations 54 also may be configured to communicate directly with each other, without the intervention of the access point 52, which may be termed ad-hoc mode or peer-to-peer mode. The wireless stations 54 may comprise desktop computers, notebook computers, computer-related equipment in general, or any type of device that is desired to be used in a communication network.

In accordance with a preferred embodiment of the disclosure, each access point 52 and each wireless station 54 may form packets comprised of multiple OFDM symbols containing data to be transmitted to another device. Each symbol comprises a plurality of data tones, and the device, either the wireless station 54 or the access point 52, preferably varies the number of data tones among the various symbols that are transmitted to another device. As such, some symbols may comprise more data tones than other symbols comprise.

Turning now to FIG. 2, a diagram depicts two exemplary symbols 60 and 70. Symbol 60 comprises 48 data tones 62, 4 pilot tones 65, and 12 unused tones 66 for a total of 64 tones. Symbol 70 comprises 52 data tones 72, no pilot tones, and 12 unused tones 66 for a total of 64 tones. As shown, the number of unused tones may be the same between the symbols 60 and 70. The frequencies used for the pilot tones in symbol 60 have been recruited to be used as data tones for symbol 70. Because symbol 70 has more data tones 62 than symbol 60, symbol 70 advantageously is able to transmit more data than symbol 60. This provides a higher data transmission rate. As explained above, the pilot tones are used by the receiver of the symbol in the demodulation process. The wireless network 50 generally functions poorly without pilot tones, but in accordance with the preferred embodiment, not every transmitted symbol need have pilot tones. Thus, the data may be transmitted from one device to another in the wireless network 50 as symbols that may or may not have pilot tones.

Turning now to FIG. 3, a block diagram shows the access point 52 in wireless communication with the wireless station 54. The wireless station 54 includes two antennas 59—a first antenna 59a and a second antenna 59b. The access point 52 includes two antennas 68—a third antenna 68a and a fourth antenna 68b. Two wireless communication channels 69 —a first wireless channel A 69a from the first antenna 59a to the third antenna 68a and a second wireless channel B 69b from the second antenna 59b to the fourth antenna 68b—are established between the wireless station 54 and the access point 52. Independent streams of data, comprised of symbols 60 and/or symbols 70, may be transmitted over the two wireless communication channels 69—a first data stream and a second data stream. The two wireless communication channels 69 are bidirectional, and data may flow in both directions through the two wireless communication channels 69. The two antennas 68 associated with the access point 52 may be located relatively close together, for example about Y2 wavelength apart. Similarly, the two antennas 59 associated with the wireless station 54 may be located relatively close together, such as about ½ wavelength apart. For example, if the wireless frequency is about 2.5 GHz, ½ wavelength would equate to about or less than 2.36 inches (6 cm) (the exemplary calculation of 2.36 inches is based on the speed of propagation in free space, whereas the communication network 50 may operate in an environment with a reduced speed of propagation and hence exhibit a shorter wavelength).

In an embodiment, the wireless station 54 may have a single antenna 59a over which the wireless station 54 may receive the first wireless channel A from the third antenna 68a and the second wireless channel B from the fourth antenna 68b. In this embodiment, a transmitter, for example the access point 52, sends symbols on channel A and channel B concurrently, in the same frequency band. The transmitter sends each of the symbols twice. The transmitter may use various combinations of the symbols to allow simplification in the processing at the receiver. On one channel, for example channel A, the transmitter sends a first symbol and then sends a second symbol while on the other channel, for example channel B, the transmitter sends the negative of the complex conjugate of the second symbol and then sends a complex conjugate of the first symbol. The receiver, the wireless station 54, receives the symbols sent concurrently on channel A and channel B, discriminating the channel A symbols from the channel B symbols through processing algorithms known to those skilled in the art. While the data throughput rate of this configuration, which may be referred to as a 2×1 configuration, is the same as the 1×1 configuration, the communication mechanism may be more robust for the 2×1 configuration.

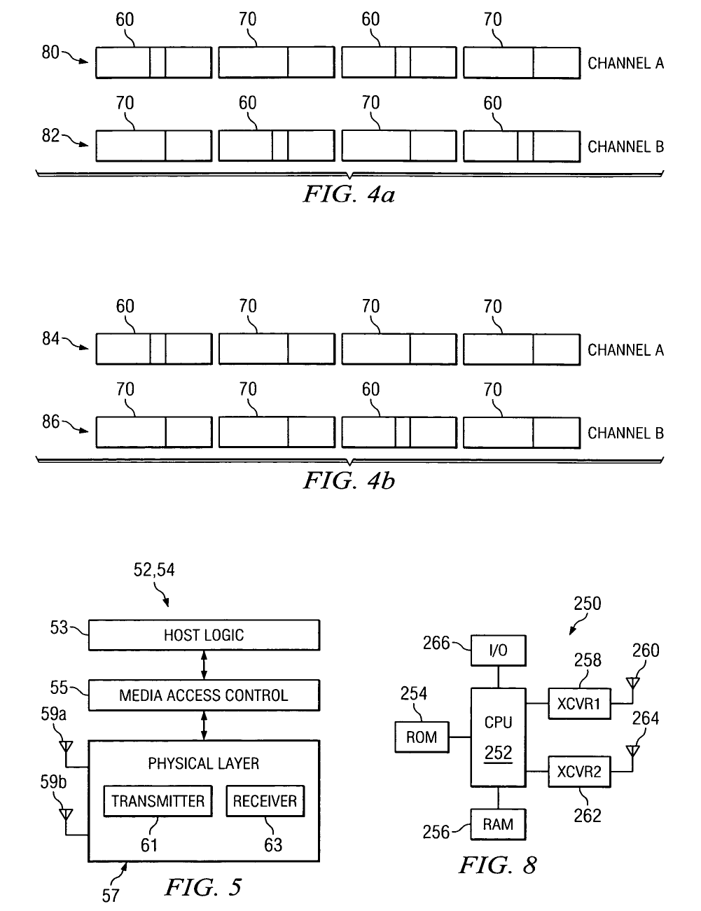

Turning now to FIG. 4a, an exemplary first sequence of symbols 80 sent by the first antenna 59a over the first wireless channel A 69a and an exemplary second sequence of symbols 82 sent by the second antenna 59b over the second wireless channel B 69b are depicted. In general, different OFDM symbols are sent on each antenna 59. The data sent in the data tones of each of the sequences of symbols 80 and 82 is different and individual. The two sequences of symbols 80 and 82 are sent substantially concurrently.

In this example, pilot tones are being transmitted from one antenna 59, for example antenna 59a, at the same time and at the same frequency that data tones are being transmitted by the alternate antenna 59, for example 59b. A receiver 63 in the wireless station 54, for example, may process the two sequences of symbols 80 and 82 using a generic multiple input multiple output (MIMO) processing algorithm such as zero forcing or minimum mean-square error, and use the resulting estimate of the pilot tone in a pilot tracking algorithm. While in this example, the communication was transmitted by the antennas 68 coupled to the access point 52 and received by the antennas 59 coupled to the wireless station 54, in another example the communication may be transmitted by the antennas 59 coupled to the wireless station 54 and received by the antennas 68 coupled to the access point 52.

The pilot tone pattern of the first sequence of symbols 80 may be represented as 4-0-4-0 repeating. The pilot tone pattern of the second sequence of symbols 82 may be represented as 0-4-0-4 repeating. According to these pilot tone patterns, 400 data tones are transmitted in 8 symbols, realizing an average of 50 data tones per symbol, an increase over the 48 data tones per symbol when using 4 pilot tones per symbol.

Turning now to FIG. 4b, an exemplary third sequence of symbols 84 sent by the first antenna 59a over the first wireless channel A 69a and an exemplary fourth sequence of symbols 86 sent by the second antenna 59b over the second wireless channel B 69b are depicted. In general, different OFDM symbols are sent on each antenna 59, and the two sequences of symbols 84 and 86 are sent substantially concurrently. The pilot tone pattern of the third sequence of symbols 84 may be represented as 4-0-0-0 repeating. The pilot tone pattern of the fourth sequence of symbols 86 may be represented as 0-0-4-0 repeating. According to these pilot tone patterns, 408 data tones are transmitted in 8 symbols, realizing an average of 51 data tones per symbol, an increase over the 48 data tones per symbol when using 4 pilot tones per symbol and an increase over the 50 data tones per symbol average depicted in FIG. 4a.

It will be readily appreciated by one skilled in the art that other pilot tone patterns may be employed to achieve other data tone per symbol averages. In practice, the pilot tone pattern may be negotiated between the access point 52 and the wireless station 54 to achieve an optimum throughput of data tones as constrained by the current wireless operating environment or by the operating characteristics of the access point 52 and/or the wireless station 54. For example, in a noisy wireless environment, the optimum throughput of data tones may be lower than the optimum throughput in a noise-free wireless environment. Because the transmit antennas 59 or 68 are nominally synchronized, transmitting pilot tones in every symbol from both antennas 59 or 68 may unnecessarily duplicate information. The present disclosure contemplates reducing the duplication of pilot tone information to obtain the benefit of increasing data throughput. To reduce the duplication of pilot tone information, when one communication channel 69 transmits a symbol containing pilot tones, the other communication channel 69 may transmit a symbol containing zero pilot tones.

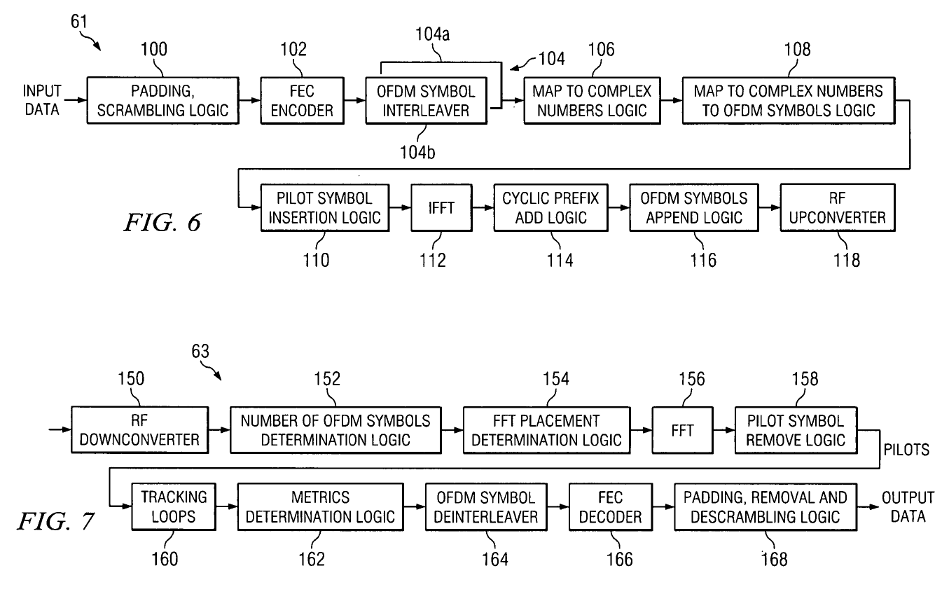

Turning to FIG. 5, an exemplary block diagram depicts at least a portion of the wireless station 54. The wireless station 54 comprises a host logic component 53, a media access control (MAC) component 55, and a physical component 57. The media access control component 55 may be said to provide a MAC layer of processing, and the physical component 57 may be said to provide a physical layer of processing. The host logic component 53 couples to the media access control component 55, and the media access control component 55 couples to the physical component 57. The host logic component 53 provides the specific functionality of the wireless station 54. The media access control component 55 receives data from the host logic component 53 and formats the data into packets that conform to the protocol to which the network 50 adheres. For example, the media access control component 55 may form a packet that includes data from the host logic component 53 as well as a preamble and/or header that provides relevant routing information. The physical component 57 couples to the first antenna 59a and the second antenna 59b through which the wireless station 54 wirelessly communicates with the access point 52, with other wireless stations 54, and, possibly, other access points 52 in the network 50. The physical component 57 receives packets from the media access control component 55 and processes the packets to ensure successful transmission through the wireless network 50. Packets from other devices, for example the access point 52 or another wireless station 54 in the wireless network 50, may be received by the physical component 57 and provided to the host logic component 53 through the media access control component 55. The physical component 57 comprises a transmitter 61 and a receiver 63 which are detailed below in FIGS. 6 and 7. While the description above was directed to the wireless station 54, the description and drawing apply to the access point 52 with the understanding that the third antenna 68a and the fourth antenna 68b are associated with the access point 52 rather than the first antenna 59a and the second antenna 59b.

Turning to FIG. 6, an exemplary block diagram of a single channel of the transmitter 61 of the physical component 57 is depicted. The other channel of the transmitter 61 is of identical or similar structure. Each of the two channels of the transmitter 61 generates independent streams of symbols, each stream containing at least partially unique data. The transmitter 61 comprises padding and scrambling logic 100, forward error correction (FEC) encoder 102, one or more symbol interleavers 104a, 104b, map to complex numbers logic 106, map complex numbers to OFDM symbols logic 108, pilot symbol insertion logic 110, inverse fast Fourier transformer (IFFT) 112, cyclic prefix add logic 114, OFDM symbol append logic 116, and radio frequency upconverter 118.

The padding and scrambling logic 100 acts as follows. The padding logic adds pad bits at the end of the input data to accommodate encoder tailing and mapping to an integer number of OFDM symbols. The scrambling logic scrambles the data using a packet-specific seed, to ensure that if a retransmission is required, the transmitted packet will not be exactly the same.

The forward error correction encoder 102 guards against data loss due to interference and multipath. Any suitable technique for performing forward error correction may be employed. The forward error correction encoder 102 receives the transmitted bit sequence from the padding and scrambling logic 100 as input, computes a corresponding set of coded bits according to a deterministic rule, and outputs the coded bits.

The symbol interleavers 104 receive the encoded bits from the forward error correction encoder 102. In general, an interleaver, for example an interleaver suitable for IEEE 802.11a communications, takes the coded bits that will be mapped to a single OFDM symbol and interleaves, i.e., scrambles, the bits according to a known pattem. For example, for 802.11a communicates at 54 megabits per second (Mbps), there are six coded bits per tone and 48 data tones. As such, there are 6×48=288 coded bits for each OFDM symbol. Therefore, for typical IEEE 802.11a systems, the coded bit stream is divided into blocks of 288 bits, and each 288 bit block is scrambled within itself.

In accordance with the preferred embodiments, however, the symbols have a variable number of data tones. For example, some symbols have 48 data tones while other symbols have 52 data tones as explained above. Because of this variation in the number of data tones per symbol, the division of the coded bit stream must vary to correspond with the varying number of data tones. In the example of 48 data tones in some symbols and 52 data tones in other symbols, the 48 data tone symbols will have 288 coded bits. Each 52 data tone symbol, however, will have 6×52=312 bits. As such, two interleavers 104a and 104b are provided to accommodate 288 coded bits for some symbols and 312 coded bits for other symbols. Any suitable interleaving algorithm can be used for the interleavers 104.

The map to complex numbers logic 106 maps the interleaved bits to complex numbers in accordance with known techniques. The map complex numbers to OFDM symbols logic 108 preferably takes the set of mapped complex numbers and maps the complex numbers onto the data tones. The mapping logic 108 takes into account the number and location of the data tones in the frequency domain.

The pilot symbol insertion logic 110 processes the mapped data to add pilot tones in accordance with the pilot tone requirements of the applicable symbol being generated by the transmitter. In the example given above, a symbol with 48 data tones, for example symbol 60, has four pilot tones, while a symbol with 52 data tones, for example symbol 70, has zero pilot tones.

The inverse fast Fourier transformer 112 converts the bits received from the pilot symbol insertion logic from the frequency domain to the time domain. The cyclic prefix add logic 114 generally duplicates the end portion of the time domain signal and prepends it to the beginning of the time domain signal. The cyclic prefix add logic 114 may be included to enable the frequency domain equalization that may be included in the receiver 63.

The OFDM symbol append logic 116 appends the time domain signals corresponding to each OFDM symbol one after another. Finally, the radio frequency upconverter 118 converts the symbol to an appropriate radio frequency signal for transmission across the wireless network.

Turning now to FIG. 7, an exemplary block diagram of a single channel of the receiver 63 of the physical component 57 is depicted. The other channel of the receiver 63 is of identical or similar structure. Each of the two channels of the receiver 63 receive independent streams of symbols, each stream containing at least partially unique data. The receiver 63 comprises a radio frequency downconverter 150, a number of OFDM symbols determination logic 152, a fast Fourier transform placement determination logic 154, a fast Fourier transformer 156, a pilot symbol remove logic 158, a tracking loops component 160, a metrics determination logic 162, an OFDM symbol deinterleaver 164, a forward error correction decoder 166, and a padding removal and descrambling logic 168. The functional units shown in the receiver of FIG. 7 generally reverse the processes described above and shown in FIG. 6.

The radio frequency downconverter 150 receives the transmitted radio signal and demodulates the radio signal to recover the transmitted symbol. The number of OFDM symbols determination logic 152 receives the downconverted signal and, from the received signal, determines the number of symbols. The fast Fourier transformer placement determination logic 154 determines a suitable interval in which to take the samples from the received sequence in order to take the fast Fourier transform for that symbol. The fast Fourier transformer 156 converts the signal from the fast Fourier transform placement determination logic 154 from the time domain into the frequency domain.

The pilot symbol remove logic 158 removes any pilot symbols that may be present. Symbols that have 48 data tones, such as the symbol 60, require the four pilot tones to be removed, while symbols having 52 data tones, such as the symbol 70, do not have pilot tones and thus do not require pilot tone removal. The tracking loops component 160 uses information derived from the pilot symbols to compensate for the cumulative effects of impairments and mismatches such as frequency offset.

The receiving device, for example the wireless station 54, needs to know the pattern of how the number of data tones per OFDM symbol varies for each of the two wireless communication channels 69. There are several techniques to achieve this feature. One technique is for the access point 52 to broadcast a single policy for the entire network 50 in each beacon. A beacon is a packet broadcast by the access point 52 to synchronize the wireless network 50 and to provide other information. The beacon may include an address of the access point 52, a time stamp, an identification of the service area of the wireless network 50, traffic delivery metrics, and/or other information. This can be done by utilizing selected bits in the regularly transmitted beacon to select from a finite, predetermined list of policies known to all wireless stations 52. Alternatively, a protocol for packet headers may be adopted in which the transmitter signals the policy for that packet in the packet header and the receiver decodes the header first and can apply the resulting pattern for the data payload. These techniques are given as examples only. The exact method is not essential for this disclosure.

The metrics determination logic 162 derives reliability information for bits at the input to the forward error correction decoder 166 from the received signals of the data tones and from the channel estimates. The OFDM symbol deinterleaver 164 generally reverses the process implemented by the symbol interleavers 104 of FIG. 6. The forward error correction decoder 166 decodes the encoded bit stream received from the OFDM symbol deinterleaver 164. The forward error correction decoder 166 has knowledge of all of the coded bit sequences that can possibly result from the encoding process. The forward error correction decoder 166 preferably keeps a running comparison of the coded bit sequence that is recovered against all known coded bit sequences. The forward error correction decoder 166 retains the best matches and after a certain amount of data has been recovered, the forward error correction decoder 166 makes an estimate of the correct decoded bit sequence.

By comparing the bit sequence recovered versus all known transmit coded bit sequences, the forward error correction decoder 166 can predict the value of the original transmitted bit sequence. Provided with this information, the forward error correction decoder 166 can detect and correct an error. The padding removal and descrambling logic 168 reverses the scrambling procedure described above with reference to FIG. 6. One or more advantages of the disclosed subject matter are possible. Flexibility is enabled by providing two basic symbol frameworks, for example the form of the symbol 60 and the form of the symbol 70. As such the frameworks can be mixed and matched to achieve a larger number of possible numbers of data tones per symbol. The second advantage is that of at least partial reuse of the conventional architecture, in that the position and number of pilot tones, if present, is according to the conventional symbol framework.

The access point 52 or the wireless station 54 described above may be implemented on any communication device such as is well known to those skilled in the art. An exemplary system 250 for implementing one or more embodiments disclosed herein is illustrated in FIG. 8. The system 250 includes a processor 252 (which may be referred to as a central processor unit or CPU) that is coupled to memory devices including a read only memory (ROM) 254, a random access memory (RAM) 256, a first transceiver 258 that is coupled to a first antenna 260, a second transceiver 262 that is coupled to a second antenna 264, and an input/output (I/O) device 266. The processor may be implemented as one or more CPU chips.

The ROM 254 is used to store instructions and perhaps data which are read during program execution. ROM 254 is a non-volatile memory device. The RAM 256 is used to store volatile data and perhaps to store instructions. The ROM 254 may include flash memories or electrically erasable programmable memory to support updating the stored instructions remotely, for example through an over-the-air interface via the transceivers 258 and/or 262 and the antennas 260 and/or 264.

The transceivers 258, 262 and the antennas 260, 264 support radio communications. The I/O device 266 may be a keypad and a visual display such as a liquid crystal display to permit entering numbers and selecting functions. Alternatively, the I/O device 266 maybe a keyboard and a touch pad, such as a keyboard and a touch pad of a laptop computer. The processor 252 executes instructions, codes, computer programs, scripts which it accesses from ROM 254 or RAM 256.

The several embodiments of the disclosure describe above each are directed to increasing data throughput by reclaiming pilot tones to use for transmitting data in such a way as to not diminish the ability of receivers to synchronize or remain synchronized.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein, but may be modified within the scope of the appended claims along with their full scope of equivalents. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as directly coupled or communicating with each other may be coupled through some interface or device, such that the items may no longer be considered directly coupled to each other but may still be indirectly coupled and in communication, whether electrically, mechanically, or otherwise with one another. Other examples of changes, substitutions, and alterations are ascertainable by one skilled in the art and could be made without departing from the spirit and scope disclosed herein.

1. A wireless device, comprising:
host logic;
at least two antennas; and
network interface logic operable to transmit packets comprising symbols containing a plurality of data tones on at least two channels and wherein the network interface logic varies the number of data tones among the symbols, a first channel of packets transmitted over a first antenna and a second channel of packets transmitted over a second antenna.

2. The wireless device of claim 1, wherein some symbols transmitted by the network interface logic comprise pilot tones that are used to facilitate demodulation and other symbols do not have pilot tones.

3. The wireless device of claim 2, wherein some symbols comprise 48 data tones and 4 pilot tones and other symbols comprise 52 data tones and zero pilot tones.

4. The wireless device of claim 1, wherein the number of data tones is varied according to user input.

5. The wireless device of claim 1, wherein the number of data tones is varied by the network interface logic according to the conditions of the wireless environment.

6. The wireless device of claim 1, wherein the network interface logic varies the number of data tones per symbol within the packet so as to comprise a first number of data tones and a second number of data tones, and wherein the first number is greater than the second number and more symbols per packet are transmitted by the network interface logic having the first number of data tones.

7. The wireless device of claim 1, wherein the network interface logic transmits a first sequence of symbols on the first channel and concurrently transmits a second sequence of symbols on the second channel and such that when a symbol of the first sequence of symbols transmitted on the first channel contains pilot tones, the concurrently transmitted symbol of the second sequence of symbols on the second channel contains zero pilot tones and when the symbol of the second sequence of symbols transmitted on the second channel contains pilot tones, the concurrently transmitted symbol of the first sequence of symbols on the first channel contains zero pilot tones.

8. The wireless device of claim 7, wherein the first sequence of symbols contains pilot tones on odd numbered symbols and the second sequence of symbols contains pilot tones on even numbered symbols.

9. The wireless device of claim 7, wherein the first sequence of symbols contains pilot tones on alternate even numbered symbols and the second sequence of symbols contains pilot tones on those even numbered symbols for which the concurrent symbol of the first sequence of symbols contains no pilot tones.

10. A wireless device, comprising:
one or more antennas; and
a receiver component in communication with the one or more antennas operable to receive two channels of packetized information containing symbols including a variable number of data tones, the two channels including a first channel of packetized information and a second channel of packetized information.

11. The wireless device of claim 10, wherein the two channels of packetized information occupy the same frequency band and include a variable number of data tones.

12. The wireless device of claim 10, wherein some symbols include pilot tones that are used to facilitate demodulation and other symbols include no pilot tones.

13. The wireless device of claim 12, wherein when a first symbol is received on the first channel and includes pilot tones, a second symbol is received substantially concurrently with the first symbol on the second channel and includes no pilot tones, and wherein when a third symbol is received on the second channel and includes pilot tones, a fourth symbol is received substantially concurrently with the third symbol on the first channel and includes no pilot tones.

14. The wireless device of claim 12, wherein some symbols comprise 48 data tones and 4 pilot tones and other symbols comprise 52 data tones and zero pilot tones.

15. The wireless device of claim 10, wherein the number of data tones is varied among the symbols according to user control inputs.

16. The wireless device of claim 10, wherein the number of data tones is varied among the symbols according to the environment of the wireless device.

17. A method for wireless communication, comprising:
determining a number of data tones to include in a first symbol for a first channel and a second symbol for a second channel;
forming the first symbol with the determined number of data tones;
forming the second symbol with the determined number of data tones;
transmitting the first symbol on the first channel from a first antenna and the second symbol on the second channel from a second antenna; and
changing the number of data tones to form another symbol for the first channel or the second channel.

18. The method of claim 17, further comprising varying the number of pilot tones in one of the first and second symbols.

19. The method of claim 17, wherein when the first symbol includes 48 data tones and 4 pilot tones the second symbol includes 52 data tones and zero pilot tones and when the second symbol includes 48 data tones and 4 pilot tones the first symbol includes 52 data tones and zero pilot tones.

20. The method of claim 17, wherein the changing the number of data tones to form another symbol for the first channel or the second channel involves providing pilot tones for odd numbered symbols and no pilot tones for even numbered symbols on the first channel and providing pilot tones for even numbered symbols and no pilot tones for odd numbered symbols on the second channel.
